(19) United States
(12) Patent Application Publication
(10) Pub. No.: US 2024/0247679 A1
(43) Pub. Date: Jul. 25, 2024

(54) INJECTION WASHER FOR AN ANCHOR SYSTEM

(71) Applicant: Black & Decker Inc., New Britain, CT (US)

(72) Inventors: Philipp MAHRENHOLTZ, Frankfurt (DE); Matthew CHAMBERLAIN, Bethel, CT (US)

(21) Appl. No.: 18/159,034

(22) Filed: Jan. 24, 2023

(51) Int. Cl. F16B 43/00; F16B 13/06

(52) U.S. Cl. CPC F16B 43/00; F16B 13/063

(57) ABSTRACT

An injection washer for an anchor system having a rod portion fixed to a surface, the injection washer including first and second opening portions arranged relative to each other along an axis parallel with the rod portion in use and which together define an opening through which the rod portion extends in use, the first opening portion having a smaller width than the second opening portion in a direction perpendicular to the rod portion and wherein a gap extends through a side of the injection washer into each of the first and second opening portions.

### FIELD OF THE INVENTION

This specification concerns injection washers for anchor systems which secure objects to surfaces e.g. concrete.

### BACKGROUND OF THE INVENTION

To fix an object to concrete it is known to use a mechanical anchor such as an expansion anchor which is basically a threaded rod with an expansion portion. The expansion portion is wedged in a hole drilled in a concrete surface leaving the threaded rod protruding out of the hole. An object is secured in place by causing the threaded rod to extend through a hole in the object to be secured. A washer is then provided around the threaded rod. Finally, a nut is wound onto the threaded rod for clamping the object between the washer and the concrete surface.

An alternative way of fixing an object to concrete is to use a chemical anchor which is basically industrial adhesive. Chemical anchor product is injected into a hole drilled in concrete. Next a threaded rod is inserted into the hole leaving part of the threaded rod protruding out of the hole. When the chemical anchor hardens the threaded rod is held securely. An object is secured in place by causing the threaded rod to extend through a hole in the object to be secured. A washer is then provided around the threaded rod. Finally, a nut is wound onto the threaded rod for clamping the object between the washer and the concrete surface.

An issue with the above-mentioned techniques of securing objects to concrete is that the existence of a gap between the threaded rod and the object being secured is disadvantageous. This is because such a gap results in a degree of play in the anchor system which overtime can cause fatigue of the anchor system especially in regions prone to earthquakes. To remove the existence of such gaps, and thereby improve stability and longevity of anchor systems, an injection washer can be used. An injection washer is basically a washer having an injection channel through which adhesive, namely chemical anchor product, can be injected to fill the gap between a threaded rod and the inner surface of an object being secured.

Injection washers are known and are discussed for example in EP3365565B1.

A problem with injection washers is a user falsely believing that a gap has been filled. FIG. 1 shows an object 10 secured to a concrete surface via an anchor system. The anchor system has an expansion element 12 wedged in a hole of the concrete and a threaded rod 14 extending therefrom. A nut 16 wound onto the threaded rod 14 clamps the object 10 between the concrete surface and an injection washer 18. The injection washer has a channel 20 through which chemical anchor product, hereafter referred to as adhesive, can be injected for filling the gap between the threaded rod 14 and the internal surface of the object being secured 10. However, if the injection washer 18 is positioned in use such that the channel 20 abuts against the threaded rod 14, as illustrated in FIG. 1, then this will restrict the flow of adhesive from the channel 20. In practice, upon the flow of adhesive from the channel 20 becoming blocked, a user who is intending to fill with adhesive the gap between the threaded rod 14 and the object 10 will notice that no more adhesive can be injected into the channel 20 and will stop injecting adhesive. They will believe that they have achieved their intention of filling the gap between the threaded rod 14 and the object 10 being secured, however, they will have merely filled the channel 20 with adhesive whereby a gap still exists between the threaded rod 14 and the object 10 being secured. Accordingly, they will not have improved the stability of their anchor system, whereby the mistaken belief that they have indeed improved the stability of their anchor system can have dangerous consequences.

The present invention addresses the above-mentioned problem associated with injection washers, namely that of users having the false impression that they have filled with adhesive the gap between an object being secured and a threaded rod.

### BRIEF SUMMARY OF THE INVENTION

According to the invention there is provided the injection washer of claim 1. Optional features thereof are defined in the dependent claims 2 to 10. Further according to the invention there is provided the anchor system of claim 11.

### BRIEF DESCRIPTION OF THE DRAWINGS

Various embodiments of the invention will now be described by way of non-limiting example with reference to the accompanying drawings, in which:

FIGS. 1 illustrates an anchor system which includes an injection washer.

FIG. 2 illustrates first and second body portions of an injection washer according to a first embodiment of the present invention.

FIG. 3 illustrates an injection washer according to a first embodiment of the present invention.

FIG. 4 illustrates the injection washer of FIG. 3 in use.

FIG. 5 illustrates an injection washer according to a second embodiment of the present invention.

FIG. 6 illustrates the injection washer of FIG. 5 in use.

### DETAILED DESCRIPTION OF THE PREFERRED EMBODIMENT

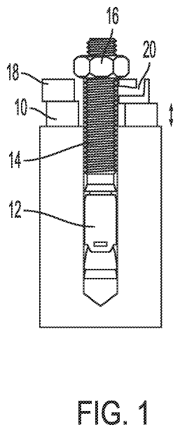

Embodiments of an injection washer according to the present invention will now be described, which in use can replace the injection washer 18 of the anchor system described in connection with FIG. 1.

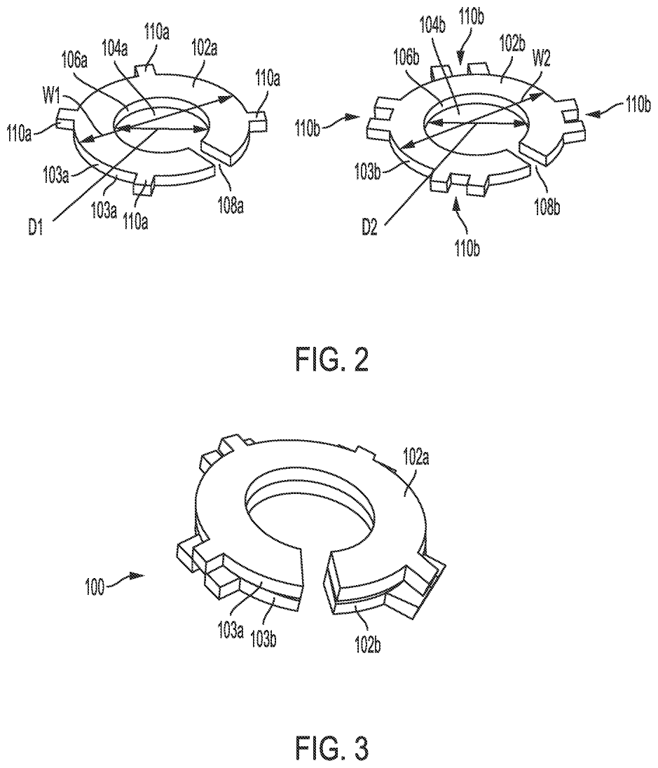

FIG. 2 shows first and second body portions 102a, 102b of an injection washer 100.

Both the first and second body portions 102a, 102b have an outwardly facing annularly extending surface. More specifically the first body portion 102a has a first annularly extending outer surface 103a, whereas the second body portion 102b has a second annularly extending outer surface 103b. The diameter W1 of the first annularly extending outer surface 103a is the same as the diameter W2 of the second annularly extending outer surface 103b, whereby the first and second body portions 102a, 102b have substantially similar outer profiles save for the alignment features 110a and 110b which are described below.

The first body portion 102a defines a first opening portion 104a. The second body portion 102b defines a second opening portion 104b. More specifically a first inwardly facing annularly extending surface 106a of the first body portion 102a defines the first opening portion 104a, whereas a second inwardly facing annularly extending surface 106b of the second body portion 102b defines the second opening portion 104b. The diameter D1 of the first opening portion 104a is smaller than the diameter D2 of the second opening portion 104b.

A gap 108a extends through the side of the first body portion 102a into the first opening portion 104a, whereby the first body portion 102a is substantially C-shaped. A gap 108b also extends through the side of the second body portion 102b into the second opening portion 104b, whereby the second body portion 102b is substantially C-shaped.

The first body portion 102a has a plurality of circumferentially distributed outwardly extending fingers 110a. The second body portion 102b has a plurality of circumferentially distributed outwardly extending finger pairs 110b. In use the first and second body portions 102a, 102b are stacked. Due to the similarity between the first and second diameters W1, W2 of the first and second annularly extending outer surfaces 103a, 103b proper axial alignment is achieved when the first and second annularly extending outer surfaces 103a, 103b align with each other as in FIG. 3. In order to achieve proper rotational alignment of the stacked body portions 102a, 102b this is facilitated by the fingers 110a and the finger pairs 110b.

Proper rotational alignment is achieved when each of the fingers 110a aligns with a gap defined by the finger pairs 110b, whereby the gap 108a of the first body portion 102a will be aligned with the gap 108b of the second body portion 102b like in FIG. 3.

Such an injection washer 100 as illustrated in FIG. 3, defined by stacked first and second body portions 102a, 102b which have been properly aligned as described above, can be used in an anchor system of the kind described in connection with FIG. 1 instead of the injection washer 18.

To fix an object to concrete an expansion portion is wedged in a hole drilled in a concrete surface leaving a threaded rod, which is connected to the expansion portion, protruding out of the hole. An object is secured in place by causing the threaded rod to extend through a hole in the object to be secured. The injection washer 100 as illustrated in FIG. 3 is then arranged around the threaded rod. In other words, the injection washer 100 is arranged on top of the object to be secured with the threaded rod extending through the opening defined by the aligned first and second opening portions 104a, 104b. A nut is then wound onto the threaded rod for clamping the object between the injection washer 100 and the concrete surface. Adhesive is then injected through the aligned gaps 108a, 108b in order to fill the gap between the threaded rod and the inner surface of the object being secured.

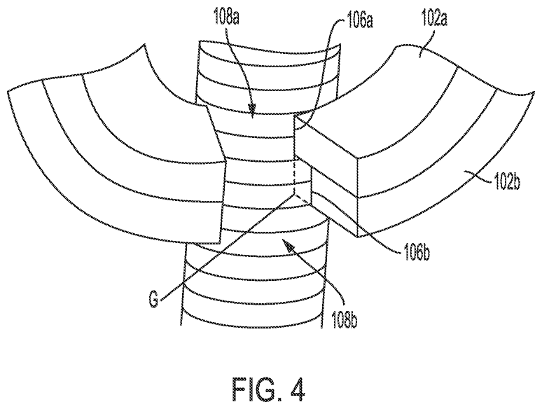

Referring to FIG. 4, advantageously even if the injection washer 100 is positioned in use such that the threaded rod abuts against the first inwardly facing annularly extending surface 106a of the first body portion 102a there will always be a gap between the threaded rod and the second inwardly facing annularly extending surface 106b of the second body portion 102b; wherein such a gap G is illustrated by the dotted lines in FIG. 4. In other words, even if the gap 108a of the first body portion 102a is blocked by the threaded rod a user will always be able to inject adhesive through the gap 108b of the second body portion 102b in use in order to fill the gap between the threaded rod and the inner surface of the object being secured. When the volume being filled cannot accommodate any more adhesive the user will be more assured that the gap between the threaded rod and the inner surface of the object being secured has indeed been filled with adhesive compared to when using the anchor system described in the background section.

The injection washer 100 can be made of metal such as steel. In some embodiments the injection washer 100 is carbon steel or stainless steel. In some embodiments the injection washer 100 is zinc plated.

In another embodiment instead of the injection washer being formed of separate body portions the injection washer is instead formed as a single piece.

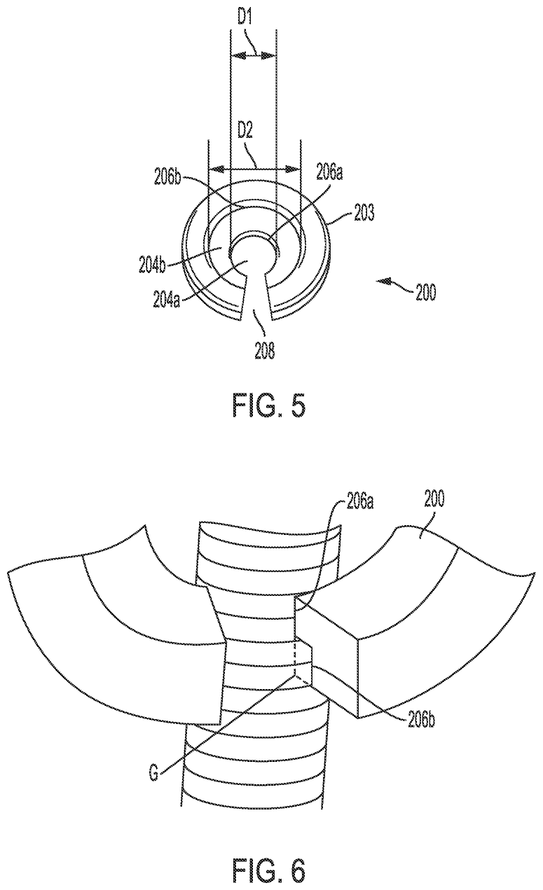

FIG. 5 shows an injection washer 200 formed as a single piece.

The injection washer 200 has an annularly extending outer surface 203.

The injection washer 200 defines a first opening portion 204a and a second opening portion 204b. More specifically a first inwardly facing annularly extending surface 206a of the injection washer 200 defines the first opening portion 204a, whereas a second inwardly facing annularly extending surface 206b of the injection washer 200 defines the second opening portion 204b. The diameter D1 of the first opening portion 204a is smaller than the diameter D2 of the second opening portion 204b.

A gap 208 extends through the side of the injection washer 200 into both the first and second opening portions 204a, 204b whereby the injection washer 200 is substantially C-shaped.

Such an injection washer 200 as illustrated in FIG. 5 can be used in an anchor system of the kind described in connection with FIG. 1 instead of the injection washer 20.

To fix an object to concrete an expansion portion is wedged in a hole drilled in a concrete surface leaving a threaded rod, which is connected to the expansion portion, protruding out of the hole. An object is secured in place by causing the threaded rod to extend through a hole in the object to be secured. The injection washer 200 as illustrated in FIG. 5 is then arranged around the threaded rod. In other words, the injection washer 200 is arranged on top of the object to be secured with the threaded rod extending through the opening defined by the first and second opening portions 204a, 204b. A nut is then wound onto the threaded rod for clamping the object between the injection washer 200 and the concrete surface. Adhesive is then injected through the gap 208 in order to fill the gap between the threaded rod and the inner surface of the object being secured.

Referring to FIG. 6, advantageously even if the injection washer 200 is positioned in use such that the threaded rod abuts against the first inwardly facing annularly extending surface 206a of the injection washer 200 there will always be a gap between the threaded rod and the second inwardly facing annularly extending surface 206b of the injection washer 200; wherein such a gap G is illustrated by the dotted lines in FIG. 6. In other words, since the diameter D1 of the first opening portion 204a is smaller than the diameter D2 of the second opening portion 204beven if the upper part of the gap 208 is blocked by the threaded rod a user will always be able to inject adhesive through the lower part of the gap 208 in use to fill the gap between the threaded rod and the inner surface of the object being secured. When the volume being filled cannot accommodate any more adhesive the user will be more assured that the gap between the threaded rod and the inner surface of the object being secured has indeed been filled with adhesive compared to when using the anchor system described in the background section.

The injection washer 200 can be made of metal such as steel. In some embodiments the injection washer 100 is carbon steel or stainless steel. In some embodiments the injection washer 100 is zinc plated.

It will be appreciated that whilst various aspects and embodiments have heretofore been described the scope of the present invention is not limited thereto and instead extends to encompass all arrangements, and modifications and alterations thereto, which fall within the spirit and scope of the appended claims.

Referring to FIGS. 2 and 3 in some embodiments the injection washer 100 may have fewer or more alignment features. For example, the first body portion may only have a single finger 110a and the second body portion 110b may only have a single finger pair 110b. In some embodiments the alignment features may be different. For example, instead of the second body portion having finger pairs 110b it may instead just have fingers 110a located in substantially similar places around the second body portion 102b as those on the first body portion 102a, whereby to rotationally align the first and second body portions 102a, 102b the user needs to align the fingers 110a on the first body portion 102a with those on the second body portion 102b.

In some embodiments the injection washer 100 may omit alignment features and thus neither of the first and second body portions 102a, 102b have any fingers 110a or finger pairs 110b; naturally this places a greater burden on the user to properly align the first and second body portions 102a, 102b in use.

The injection washer 100, 200 heretofore described can be used in anchor systems which omit a nut for squeezing against the injection washer 100, 200 in order to secure an object between a surface and the injection washer 100, 200. For example, in some concrete screw anchors a head section of the concrete screw anchor engages an object being secured to a surface in order to squeeze the object between the head section and the surface. More specifically in some concrete screw anchors a front part of the concrete screw anchor is configured to tap a thread into a bore drilled in a concrete surface whereas a rear end of the concrete screw anchor is provided with a head section; the concrete screw anchor being essentially rod-like between the front and rear ends. In order to secure an object to a concrete surface a hole is drilled in the concrete. A hole extending through the object to be secured is then aligned with the hole in the concrete. The front part of a concrete screw anchor is then caused to extend through such aligned holes, whereby the concrete screw anchor is subsequently turned in order to draw itself into threaded engagement with the hole drilled in the concrete. As the concrete screw anchor progressively draws itself into the hole in the concrete the head section provided at the rear end of the concrete screw anchor moves closer towards the object being secured, eventually touching it. Eventually the object being secured is squeezed by the head section against concrete surface for securing the object in place. An injection washer 100, 200 heretofore described can be used in such an anchor system between the object being secured and the head section. In particular by causing the concrete screw anchor to extend through the injection washer 100, 200, and for the head section of the concrete screw anchor to squeeze the object being secured against the concrete surface via the injection washer 100, 200, this will enable a user to fill the space between the object being secured and the rod-like part of the concrete screw anchor with adhesive to improve stability and longevity of the anchor system in use.

What is claimed is:

1. An injection washer for an anchor system having a rod portion fixed to a surface, the injection washer comprising first and second opening portions arranged relative to each other along an axis parallel with the rod portion in use and which together define an opening through which the rod portion extends in use, the first opening portion having a smaller width than the second opening portion in a direction perpendicular to the rod portion and wherein a gap extends through a side of the injection washer into each of the first and second opening portions.

2. The injection washer of claim 1, wherein the injection washer is formed as a single piece.

3. The injection washer of claim 2, wherein the first opening portion is defined by a first inner surface portion of the injection washer and the second opening portion is defined by a second inner surface portion of the injection washer.

4. The injection washer of claim 3, wherein the first and second opening portions are substantially circular and the first opening portion has a smaller diameter than the second opening portion.

5. The injection washer of claim 2, wherein the injection washer is substantially C-shaped.

6. The injection washer of claim 1, wherein the injection washer is not formed as a single piece wherein the first opening portion is defined by a first body portion and the second opening portion is defined by a separate second body portion, the first and second body portions being stacked together in use and having substantially similar outer profiles around at least some of the external surfaces thereof.

7. The injection washer of claim 6, wherein the first and second opening portions are substantially circular and the first opening portion has a smaller diameter than the second opening portion.

8. The injection washer of claim 7, wherein the first body portion and the second body portion are each substantially C-shaped.

9. The injection washer of claim 6, wherein the first and second body portions each have externally arranged alignment features for enabling a user to determine if the first and second body portions have been rotationally aligned in use, whereby upon successful rotational alignment the gap extending through the side of the first body portion into the first opening portion aligns with the gap extending through the side of the second body portion into the second opening portion.

10. The injection washer of claim 9, wherein one of the first body portion and the second body portion has at least one externally extending first finger and the other thereof has at least two externally extending second fingers, wherein the first finger aligns with a gap between the second fingers when the first and second body portions have been properly aligned in use.

11. An anchor system comprising: a rod portion fixed to a surface and an injection washer according to claim 1.
